(19) United States
(12) Patent Application Publication
(10) Pub. No.: US 2008/0126042 A1
(43) Pub. Date: May 29, 2008

(54) System And Method For Optimum Phasing Of A Three-Shaft Steering Column

(76) Inventor: Tyler T. Kim, Novi, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/466,484

(22) Filed: Aug. 23, 2006

(51) Int. Cl. G06G 7/70

(52) U.S. Cl. 703/8

(57) ABSTRACT

A method of phasing u-joints of a steering shaft assembly in a three shaft, two u-joint arrangement involves inputting steering shaft assembly coordinates to a first spreadsheet, generating a computer-aided design image of the steering shaft assembly based on the steering shaft assembly coordinates, performing kinematics calculations of the steering shaft assembly using the computer-aided design image, exporting kinematics calculation results to a second spreadsheet, graphing relative steering shaft assembly speeds relative to a rotational position of the steering shaft assembly in accordance with the kinematics data, analyzing graphs of the steering shaft assembly speeds for phasing compliance, and analyzing graphs of the steering shaft assembly speeds for relative speed compliance. Finally, phasing the yokes on either end of the intermediate shaft of the steering shaft assembly in accordance with the speed of the steering shaft and the speed of the gearbox input shaft is accomplished.

### FIELD OF THE INVENTION

The present invention relates to a system and method of optimum phasing of a three-shaft steering column.

### BACKGROUND OF THE INVENTION

Modern vehicles may employ one of various configurations of steering shafts connected with universal joints and packaged within a front end of a vehicle, usually around the engine and associated components that are all packaged under a vehicle hood. However, due to such packaging requirements, the differences in torques and velocity between the steering shaft and the steering gear shaft are greater than what is optimum or desired. Suboptimum and undesirable differences between such quantities may be detected in the steering wheel by a person who turns the steering wheel. More specifically, when the steering wheel is connected to a non-optimized steering shaft—universal joint—intermediate shaft—universal joint—steering gear shaft configuration, the driver may feel the steering wheel actually increasing and decreasing in velocity as force is applied to turn the steering wheel during driving. Additionally, this may require more, and then less, force and effort to turn the wheel during a vehicle turn.

What is needed then is a device that does not suffer from the above limitations. This, in turn, will provide a method of optimally configuring a steering shaft—universal joint—intermediate shaft—universal joint—steering gear shaft arrangement. Such an optimum configuration will permit the configuration to be packaged in a vehicle's engine compartment space while permitting a steering wheel to be turned using a consistent amount of force and torque with no velocity variations in the steering wheel during such turning.

### SUMMARY OF THE INVENTION

A method of phasing a three shaft, two ujoint steering shaft assembly involves inputting steering shaft assembly coordinates to a spreadsheet and generating a CAD image of the steering shaft assembly by importing the steering shaft assembly coordinates to the CAD software. Performing kinematics analysis on the steering shaft assembly using a kinematics package of the CAD software provides shaft speeds and joint angles for the given coordinates. The kinematics software also provides a phase angle for yokes on either end of an intermediate shaft to match the rotational speed of shafts on either side of the intermediate shaft. The kinematics data is exported to another spreadsheet where graphing of the relative shaft speeds relative to a rotational position of the steering shaft assembly may be visually inspected for acceptable relative shaft speeds and phase positions.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a vehicle depicting a three piece steering shaft assembly in phantom;

FIG. 2 is a top view of a vehicle depicting the three piece steering shaft assembly of FIG. 1 in phantom;

FIG. 3 is a side view of a three piece steering shaft assembly depicting universal joints at the juncture of the shafts;

FIG. 4 is an enlarged view of a universal joint between a steering shaft and an intermediate shaft;

FIG. 5 is an enlarged view of a universal joint between an intermediate shaft and a gearbox input shaft;

FIG. 6 is an end view of an intermediate shaft depicting the spider of a first universal joint at a first end of the intermediate shaft;

FIG. 7 is an end view of the intermediate shaft of FIG. 6 depicting the spider of a second universal joint at a second end of the intermediate shaft;

FIG. 8 is an end view of the intermediate shaft depicting the spiders of FIGS. 6 and 7 in an overlaid fashion;

FIG. 9 is a side view of a three-piece steering shaft assembly noting the angles involved in setting a phase angle of an intermediate shaft;

FIG. 10 is a table spreadsheet depicting input and output parameters used in arriving at steering shaft and gearbox input shaft RPM compatibility;

FIG. 11 is a graph of Shaft RPM versus Steering Shaft Angle denoting the phase relationships of the shaft velocities of each of the shafts; and

FIG. 12 is a graph of Relative RPM Ratio versus Steering Shaft Angle denoting the phase relationships of the relative RPM ratios of each of the shafts.

### DETAILED DESCRIPTION OF THE PREFERRED EMBODIMENTS

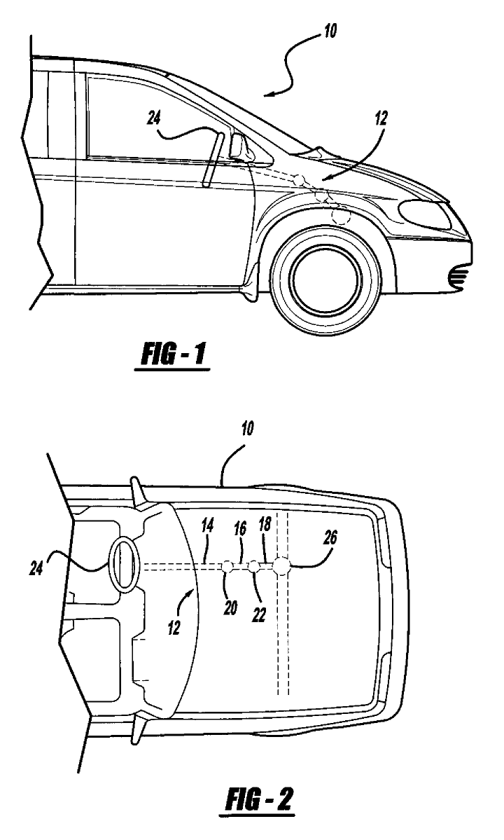

The following description of the preferred embodiments is merely exemplary in nature and is in no way intended to limit the invention, its application, or uses. FIG. 1 is a side view of a vehicle 10 depicting a three-piece steering shaft assembly in phantom, while FIG. 2 is a top view of the same steering shaft assembly 12. With continued reference to FIGS. 1 and 2, the steering shaft assembly 12 is composed of multiple pieces such as a steering shaft 14, an intermediate shaft 16 and a gearbox input shaft 18. The steering shaft assembly 12 becomes one piece when the shafts 14, 16, 18 are joined together with universal joints 20 and 22. More specifically, the steering shaft 14 and the intermediate shaft 16 are joined together with a first universal joint 20 while the gearbox input shaft 18 and the intermediate shaft 16 are jointed together with a second universal joint 22.

As depicted in FIGS. 1 and 2, the steering shaft assembly 12 becomes non-linear at the first and second universal joints 20, 22 to create the curved link necessary between the steering wheel 24, which is attached to the steering shaft 14, and the steering gearbox 26, which is attached to the gearbox input shaft 18. When viewed from above the vehicle 10, the steering shaft assembly 12 is seen largely as a straight line, although such is not necessary, and the steering shaft assembly 12 may also be bent at its universal joints 20, 22 so that in a top view such as FIG. 2, the steering shaft assembly 12 would also appear non-linear. Stated another way, the steering shaft assembly 12 may be bent in more than one plane to provide the necessary steering link from the steering wheel to the steering gearbox 26. However, for purposes of the present teachings, FIGS. 1 and 2 generally depict the arrangement of the steering shaft assembly 12.

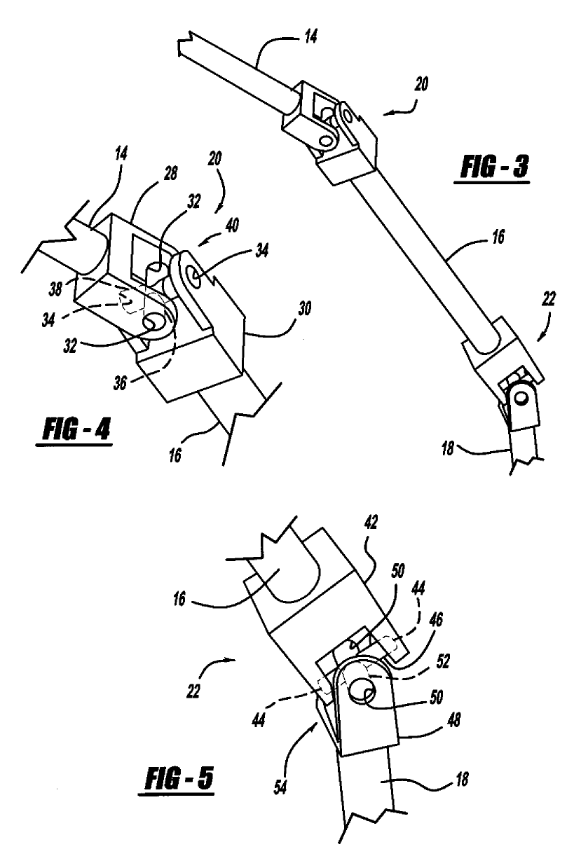

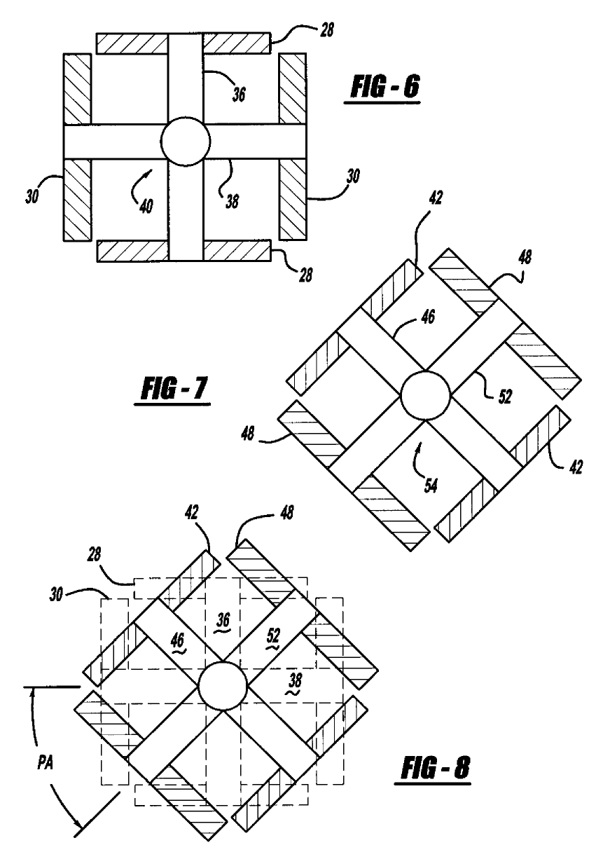

Continuing with FIG. 3, the steering shaft assembly 12 is depicted showing the first and second universal joints 20, 22 in more detail. FIG. 4 depicts the first universal joint 20 while FIG. 5 depicts the second universal joint 22. The first universal joint 20 has the steering shaft 14 as a driving shaft because the driver of a vehicle provides the rotational input to the driving shaft 14 which is then transmitted to the driven shaft, which is the intermediate shaft 16 for the first universal joint 20. The steering shaft 14 has a driving yoke 28, also referred to as a steering shaft yoke 28, attached to it, while the intermediate shaft 16 has a driven yoke 30 or first intermediate shaft yoke 30 attached to it. The steering shaft yoke 28 has a pair of eyes 32 (holes), while the first intermediate shaft yoke 30 also has a pair of eyes 34. Through the steering shaft yoke eyes 32 a steering shaft yoke pin 36 fits, while a first intermediate shaft yoke pin 38 fits within the eyes 34 of the first intermediate shaft yoke 30. The pins 36, 38 are joined together at right angles and form a first spider 40, also known as a cross.

Referring primarily to FIG. 5, the intermediate shaft 16 connects to a second intermediate shaft yoke 42 that defines a pair of second intermediate shaft yoke eyes 44 (holes). A second intermediate shaft yoke pin 46 resides within the second intermediate shaft yoke eyes 44. In FIG. 5, which depicts the second universal joint 22, the second intermediate shaft yoke 42 is the driving yoke while a gearbox shaft yoke 48 is the driven yoke. The gearbox shaft yoke 48 has a pair of holes called the gearbox shaft yoke eyes 50 within which the gearbox shaft yoke pin 52 fits. Similar to the first universal joint 20, the second universal joint 22 is connected with a second spider 54 formed by the second intermediate shaft yoke pin 46 and the gearbox shaft yoke pin 52.

The spiders 40, 54 are each solid members that have portions that intersect at 90 degrees to each other to form a uniform, single-piece spider. At the four ends of each spider 40, 54 are bearings (not shown) that permit the respective yoke 28, 30 and 42, 48 to pivot on its respective spider 40 and 54. With such an arrangement, a standard universal joint, also referred to as a Cardan Joint or Hooke Joint is created.

In the present teachings, a Cardan joint is used, which is different from a constant velocity joint in that when an angle other than zero is formed between a first shaft and a second shaft joined by a Cardan joint, the driven shaft moves through periods of varying velocity (RPM) while the driving or input shaft is rotated at a constant velocity (RPM). More specifically, a driven shaft experiences two periods of higher velocity and two periods of slower velocity than a driving shaft, for each driving shaft revolution. By using Cardan joints instead of constant velocity joints, the steering shaft assembly 12 can be made much more economically. Another advantage is that Cardan joints, relative to their constant velocity joint counterparts, require less space. From a maintenance perspective, the Cardan joint requires less lubrication because it has far fewer moving parts, and thus less friction, than its constant velocity joint counterpart. However, in order to use dual Cardan joints 20, 22 a phase angle difference of the first intermediate shaft yoke 30 and the second intermediate shaft yoke 42 must be calculated and then the yokes 30, 42 must be adjusted according to the calculated phase angle difference. This phenomena inspired the teachings of the present invention which will be presented in more detail later, but involves phasing, which is the relative rotational position of each yoke on a shaft, in the case of the present teachings, the yokes 30, 42 and the intermediate shaft 16.

A problem encountered when attempting to use Cardan joints in the steering shaft assembly 12 without making any phasing adjustments, is that a “lumpiness,” or “knuckling” may be felt in the steering wheel when a driver turns the steering wheel 24. Phasing is the term applied to rotationally adjusting the positions of each yoke, relative to each other, on a given shaft, such as the intermediate shaft 16. Such knuckling is the varying degrees of turning resistance felt as the angular velocity of the intermediate shaft 16 and the gearbox input shaft 18 change as the steering shaft 14 is turned when a driver turns the steering wheel 24. The knuckling phenomena occurs when the phase angle between the Cardan joints 20, 22 is maladjusted. More specifically, for the present teachings, the intermediate shaft 16 has a first intermediate shaft yoke 30 and a second intermediate shaft yoke 42. Both yokes 30, 42 must be rotationally attached to the intermediate shaft 16 in a manner relative to each other. Stated differently, when viewing the intermediate shaft 16 from an end of the shaft 16 with only the first and second intermediate shaft yokes 30, 42 attached, the resulting spider positions will resemble what is depicted in FIG. 8.

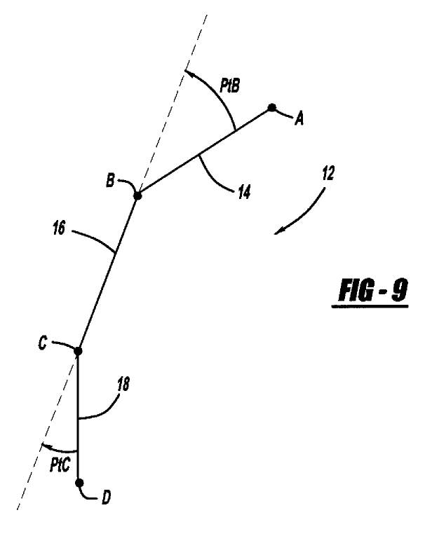

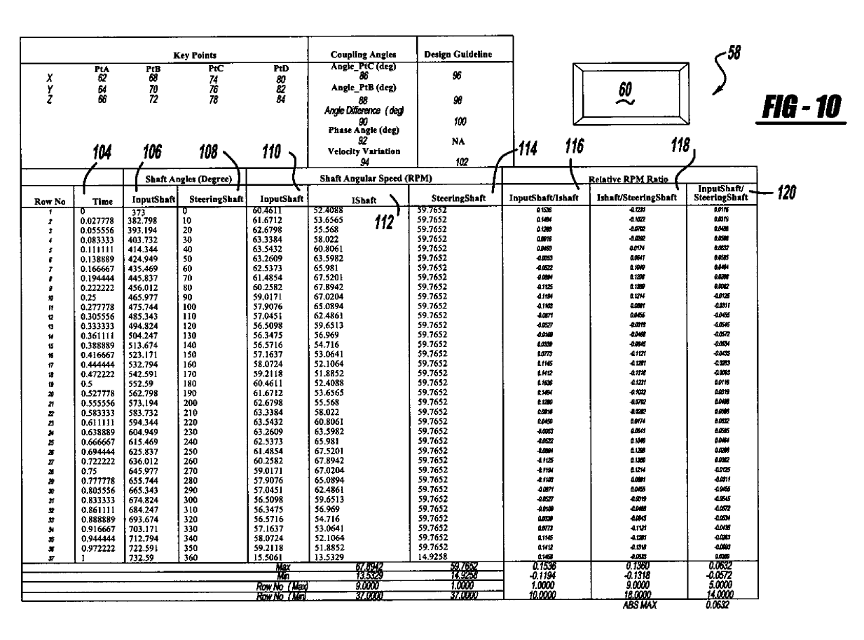

FIG. 8, which is the overlay of FIGS. 6 and 7, depicts what is seen when looking along the length of shaft 16 when viewed from the end retaining the second intermediate shaft yoke 42 and accompanying spider 54 toward the first intermediate shaft yoke 30 and its accompanying spider 40. FIG. 6 depicts the steering shaft yoke 28 and the first intermediate shaft yoke 30 with the first spider 40, which is formed by the steering shaft yoke pin 36 and the first intermediate shaft yoke pin 38. Similarly, FIG. 7 depicts the second intermediate shaft yoke 42 and the gearbox shaft yoke 48 with the second spider 54, which is formed by the second intermediate shaft yoke pin 46 and the gearbox shaft yoke pin 52.

As can be determined by viewing FIG. 8, the first intermediate shaft yoke 30 and second intermediate shaft yoke 42 are phased by 45 degrees, as indicated by the angle PA, which denotes the phase angle between the yokes. That is, they are depicted rotated relative to each other by 45 degrees; however, the direction of rotation, clockwise or counter-clockwise, depends upon what speeds the shafts are experiencing before phasing. Without proper phasing, the gearbox input shaft 18 would experience undesirable fluctuations in speeds while the steering shaft 14 is rotated, at a constant speed, regardless of direction. To quickly and accurately arrive at a desirable phase angle, called “phasing”, of the yokes 30, 42, the method of the present invention was developed.

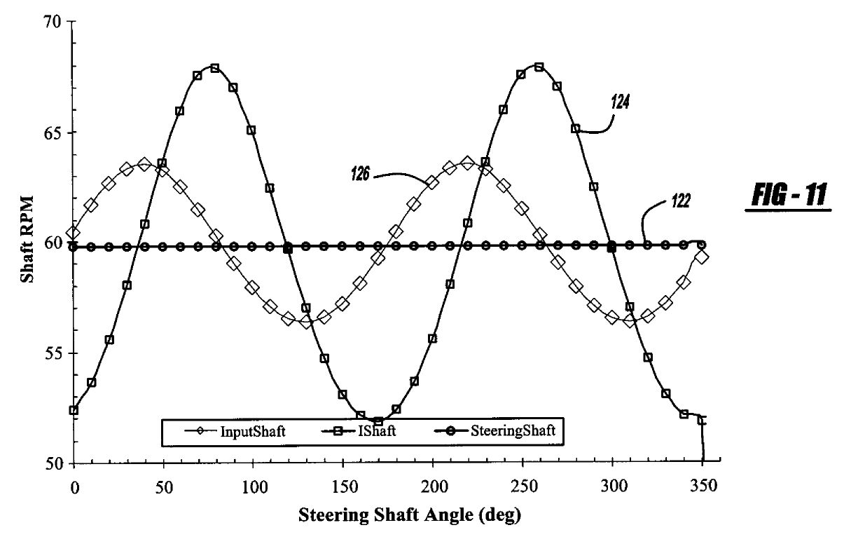

Referring now to FIGS. 9-12, a more detailed explanation of the method of the present invention will be presented. FIG. 9 is a more basic depiction of the steering shaft assembly 12 of FIG. 3. FIG. 9 further depicts four points A-D that represent the end locations of the respective shafts. That is, points A-B represent end locations of the steering shaft 14, points B-C represent end locations of the intermediate shaft 16, and points C-D represent end locations of the gearbox input shaft 18. Furthermore, points B and C represent the locations of the first and second universal joints 20 and 22. Additionally, at point B, between the steering shaft 14 and intermediate shaft 16, is an angle PtB, while at point C, between the intermediate shaft 16 and the gearbox input shaft 18, is an angle PtC. Additionally, point A represents an example location of the steering wheel 24, and point D represents an example location of the steering gearbox.

When arriving at the proper phasing angle between the first intermediate shaft yoke 30 and the second intermediate shaft yoke 42, the coupling angles PtB and PtC must each be less than 30 degrees. When the angles PtB and PtC are greater than 30 degrees the knuckling effect may still be felt in the steering wheel regardless of the phasing performed. Furthermore, the difference between the coupling angles must always be less than 3 degrees. When the difference between the coupling angles is greater than 3 degrees, the knuckling effect may still be felt in the steering wheel regardless of the phasing performed on the yokes 30, 42. To reinforce the teachings of the present invention, phasing means the relative angular rotational positions of the yoke 30 and yoke 42 to each other when viewed from an end of shaft 16.

FIG. 10 depicts a table of the parameters used to ultimately calculate the phase angle of the intermediate shaft yokes 30, 42. More specifically, the parameters are held within a spreadsheet application such as a Microsoft Excel spreadsheet (“spreadsheet”) after being downloaded from a separate software package such as Catia V5 kinematics software package (“Catia V5”) upon the Catia V5 software performing kinematics calculations. More specifically, Catia V5 is a Computer Aided Design (“CAD”) software package that permits analytical software packages such as kinematics, finite element methods, vibrations, etc. to be added and utilized in conjunction with the CAD 3-D images. The Catia V5 software becomes fully integrated when the CAD geometry is utilized by the particular analytical package. In the instance of the present invention, a kinematics software package was utilized. In the kinematics software package, coordinates corresponding to points A-D of FIG. 9 are entered into the Catia V5 software to create a graphical model.

The coordinates may be added directly into the Catia V5 software or transferred, that is, input electronically, into the Catia V5 software from a separate spreadsheet. For instance, PtA has coordinates X, Y and Z which are representative of a CAD coordinate system that points PtB, PtC, and PtD also follow. Such coordinates can be thought of as lying in the space under the hood of a vehicle and are relative to each other. The advantage of using a software package such as Catia V5 is that when a model of the steering shaft assembly 12 is displayed, interference with other parts within an engine compartment can easily be determined when those other parts are also modeled along with the steering shaft assembly 12. After the coordinates are input and the model is drawn, Catia V5 performs a kinematics analysis on the steering shaft assembly 12.

During the analysis, multiple parameters are calculated. For instance, the coupling angles of PtC 86 and PtB 88 are calculated. The PtB coupling angle is the supplement of the angle formed by the steering shaft 14 and the intermediate shaft 16. Similarly, the PtC coupling angle is the supplement of the angle formed by the intermediate shaft 16 and the gearbox input shaft 18. Although phasing can be used to reduce knuckling in a steering wheel caused when the coupling angles of PtB and PtC are not equal, or not nearly equal enough, it has been discovered that phasing in the steering shaft assembly 12 cannot overcome the feeling of knuckling when the angle difference between PtB and PtC is greater than about 3 degrees. Additionally, if either of the coupling angles PtB, PtC is greater than about 35 degrees, the steering wheel 24 will not return to its neutral or straight position after being turned and then released during a vehicle turn on a road. Therefore, in developing the teachings of the present invention, the coupling angles are maintained at less than 30 degrees to provide a satisfactory feel to the driver.

Continuing with FIG. 10, the Catia V5 software transfers data when a “Copy Catia Data” button 60 is clicked. For instance, after Catia V5 performs a kinematics analysis, and the button 60 of spreadsheet 58 is pressed, because the spreadsheet of FIG. 10 is linked to the Catia V5 software, certain parameters are transferred to the spreadsheet for ease of inspection and further analysis and graphing. For instance, locations 62-84 display the X, Y and Z coordinates for PtA-PtD of FIG. 9. Locations 86 and 88 display the PtC and Pt B angles, and location 90 displays the angle difference of PtC and PtB. Location 92 displays the suggested phase angle between the first intermediate shaft yoke 30 and the second intermediate shaft yoke 42. Catia V5 calculates the phase angle denoted in location 92 based on the input coordinates of locations 62-84. Location 94 displays the absolute value of the velocity variation between the steering shaft 14 and the gearbox input shaft 18.

Design guidelines are also verified within the spreadsheet of FIG. 10 itself. For instance, locations 96 and 98 each verify that the PtC and PtB coupling angles are each less than 30 degrees and display a green “Met” or red “Not Met” response in the spreadsheet to alert the user as to the angle difference. Location 100 displays a green “Met” response if the angle difference of location 90 is less than 3 degrees or a red “Not Met” response if the angle difference is not less than 3 degrees. Location 102 displays a green “Met” response when the absolute value of the velocity variation between the steering shaft 14 and the gearbox input shaft 18 is less than 5% (0.05) and a red “Not Met” response when such variation is not less than 5%.

Continuing with FIG. 10, various columns of kinematics data are denoted. For instance columns denoting time 104, gearbox input shaft angle 106, steering shaft angle 108, gearbox input shaft RPM 110, intermediate shaft RPM 112, and steering shaft RPM 114. Such kinematics related values of columns 104-114 are input or transferred to the spreadsheet 58 after calculations in Catia V5 are concluded. The calculations performed in the CATIA V5 software are performed in real time; that is, a user actually witnesses the 3-D image, such as FIG. 3, rotate on a computer screen while the parameters of spreadsheet 58 are calculated by the software and then output to the spreadsheet 58. The kinematics calculations required from the kinematics software running in CATIA V5, are selected as options in the kinematics software. For instance, angular velocities of shafts 14, 16 and 18 are selected, as is the necessary phase angle for the shafts 14 and 18 to have the same, or nearly the same, velocities. The coupling angles PtB, PtC are also provided. Finally, the Kinematics package has knowledge of how Cardan joints perform, so that such velocities and phasing angles can be calculated.

Upon the kinematics values of columns 104-114 being copied into the spreadsheet 58, either directly from the Catia V5 software or from another spreadsheet, which may be used simply for recording parameters before transferring them (importing) to a spreadsheet 58 such as in FIG. 10, further calculations may be performed directly in the spreadsheet 58. For instance, relative RPM ratios between various shafts are calculated: Input Shaft:lntermediate Shaft 116 [(gearbox input shaft RPM 110—intermediate shaft RPM 112)/intermediate shaft RPM 112]; Intermediate Shaft:Steering Shaft 118 [(intermediate shaft RPM 112—steering shaft RPM 114)/steering shaft RPM 114]; and Input Shaft:Steering Shaft 120 [(gearbox input shaft RPM 110—steering shaft RPM 114)/steering shaft RPM 114]. Upon calculating the values for each time of column 104, maximum and minimum relative RPM ratio values may be examined and a final maximum absolute value of the Gearbox Input Shaft:Steering Shaft 120 may be compared in location 102. Although the percentage of velocity variation between the gearbox input shaft and steering shaft at which a driver can feel knuckling varies with each steering shaft assembly 12, maintaining a maximum percentage below 5% has been discovered to provide a result in which no knuckling can be detected by a driver.

Because Catia V5 is a fully functional CAD package, when the geometry of the steering shaft assembly 12 is displayed onto a computer screen, the coupling angles of PtB and PtC (FIG. 9) and phase angle are instantly displayed making it possible for the user to instantly see results, even before any parameters are transferred to the spreadsheet of FIG. 10. Furthermore, the geometry can be changed or “morphed” on the screen to instantly see the results of such change. Therefore, the ability exists to start with a set of coordinates for the steering shaft assembly 12, and then adjust the lengths of various shafts 14, 16, 18 to arrive at a configuration that not only fits within the packaging requirements of a particular vehicle, but also that instantaneously returns a phase angle and acceptable coupling angles and associated values of FIG. 10.

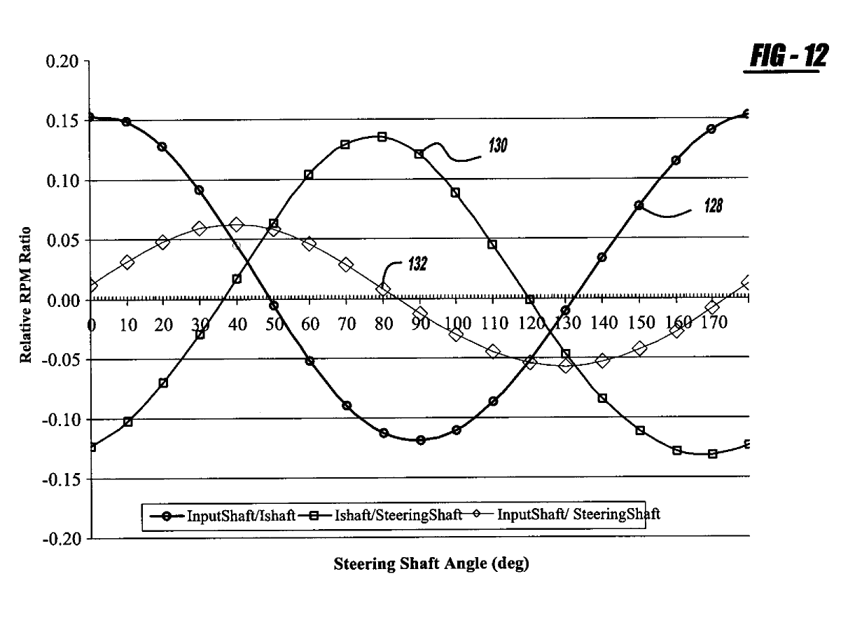

One advantage of utilizing the spreadsheet information, some of which is provided by the Catia V5 software, is that spreadsheet graphical techniques may be used to arrive at results faster than if non-graphical techniques where used. Additionally, graphs permit trends in data to be easily viewed because an entire set of data may be viewed at one time. Finally, the graphing of FIGS. 11 and 12 permit comparisons to be made among the various shafts 14, 16, 18.

FIG. 11 is a graph of Shaft RPM versus Steering Shaft Angle (degrees) for the gearbox input shaft 18, intermediate shaft 16 and steering shaft 14. More specifically, the steering shaft plot 122, intermediate shaft plot 124 and gearbox input shaft plot 126 depict the respective speeds of the shafts at respective revolution degrees of the steering shaft 14 while the steering shaft 14 is turned at a constant velocity. As depicted in FIG. 11 the intermediate shaft plot 124 shows that the intermediate shaft 16 experiences two peaks of a maximum velocity and two peaks of a minimum velocity. The plot 126 of the gearbox input shaft 18 indicates the same speed fluctuation phenomena although to a lesser degree.

As depicted by the plots of FIG. 11, the shafts are out of phase, that is, for example, if the peaks of plot 124 do not coincide with the valleys of plot 126. However, in order to determine if the relative speed variation between the steering shaft 14 and the gearbox input shaft 18 is acceptable, the plot of FIG. 12 must be examined. The ideal or optimum relative speed difference between the steering shaft and the gearbox input shaft 18 is zero.

FIG. 12 is a graph of Relative RPM Ratio versus Steering Shaft Angle (degrees). By inspecting the relative velocity plots of Gearbox Input Shaft:lntermediate Shaft 128, Intermediate Shaft:Steering Shaft 130 and Gearbox Input Shaft:Steering Shaft 132, one can see that the plot 132 has portions of it that fall outside of the 5% difference in relative velocities. By this method of graphical viewing, the exact rotational position of the Steering Shaft (degree) at the time of non-conformant relative velocity of the plot 132, is known. For the plot 132 of FIG. 12, this non-conformance occurs at approximately 22-57 degrees of rotation of the steering shaft 14 and approximately 118-142 degrees of rotation. Therefore, by adjusting the geometry such as the lengths of shafts 14, 16 18 and coupling angles PtB, PtC, of the steering shaft assembly 12 displayed in the Catia V5 software, additional values for the spreadsheet of FIG. 10 may be calculated and imported by Catia V5 software, and immediately subsequent thereto, the plots of FIGS. 11 and 12 may be performed and inspected. The coordinate points of the shafts 14, 16, 18 for each successful, that is optimized, steering shaft assembly 12, may be stored in a spreadsheet for future reference. When similar steering shaft assemblies must be designed, the stored coordinates offer an effective starting point.

Then, a method of phasing u-joints of a steering shaft assembly 12 may involve inputting steering shaft assembly coordinates to a spreadsheet. Such a spreadsheet may be spreadsheet 58 or a different spreadsheet used exclusively for input coordinates of points A, B, C and D. The advantage is that when coordinates that permit the desired rotational speeds of the steering shaft 14 and gearbox input shaft 18, such coordinates may be saved for later use in a similar vehicle application. Next, generating a computer-aided design image of the steering shaft assembly 12 based on the coordinates of the steering shaft assembly points A-D from the spreadsheet is performed. Using the computer-aided design image, kinematics calculations of the steering shaft assembly are performed using a kinematics software package that works in conjunction with the CATIA V5 software and is capable of Cardan joint calculations. The kinematics calculations results may be exported to a second spreadsheet wherefrom the results are read so that graphs may be made, such as also in a spreadsheet application. Relative steering shaft assembly speeds relative to a rotational position of the steering shaft assembly, in accordance with the kinematics data, may be graphed. Upon graphing, analyzing graphs of the steering shaft assembly speeds for phasing compliance and relative speed compliance may be performed. For phasing compliance, in FIG. 12, the peaks of plot 130 should be opposite or out of phase to plot 128, while for relative speed compliance, the plot 132 should be within 5% (0.05), meaning that the gearbox output shaft speed is within a 5% difference of the steering shaft speed.

Next, inputting the steering shaft assembly 12 coordinates may further entail inputting coordinates for the steering shaft 14, the intermediate shaft 16, and the gearbox input shaft 18. Generating a computer-aided design image of the steering shaft assembly 12 may further entail generating a 3-D image on a computer using CAD. Calculating relative RPM ratios, for one revolution of the steering shaft 14, between the gearbox input shaft 18 and the intermediate shaft 16, between intermediate shaft 16 and the steering shaft 14, between the gearbox input shaft 18 and the steering shaft 14 may be performed.

Subsequently, performing kinematics calculations of the steering shaft assembly 12 may entail calculating a revolution time interval for the steering shaft 14, calculating a gearbox input shaft angle (rotational angle) at the revolution time interval, calculating a steering shaft angle at the revolution time interval, calculating a gearbox input shaft angular speed at the revolution time interval, calculating an intermediate shaft angular speed at the revolution time interval, and calculating a steering shaft angular speed at the revolution time interval.

Exporting kinematics calculations results to a second spreadsheet entails arranging the calculations in order according to a rotational position of the steering shaft assembly 12. For instance, as the steering shaft assembly 12 is rotated through 360 degrees, values such as speed (RPM) and rotational position (degrees) are measured. Such measurements are performed using the 3-D CAD image and the kinematics module of the Catia V5 software.

Graphing steering shaft assembly speeds relative to a rotational position of the steering shaft assembly 12 further entails: graphing a steering shaft RPM versus a steering shaft rotational angle for one complete revolution; graphing an intermediate shaft RPM versus a steering shaft rotational angle for one complete revolution; and graphing a gearbox input shaft RPM versus a steering shaft rotational angle for one complete revolution.

Graphing steering shaft assembly speeds relative to a rotational position of the steering shaft assembly 12 may further entail: graphing a relative RPM ratio between a gearbox input shaft RPM and an intermediate shaft RPM in accordance with a steering shaft rotational angle for one complete revolution; graphing a relative RPM ratio between an intermediate shaft RPM and a steering shaft RPM in accordance with a steering shaft rotational angle for one complete revolution; and graphing a relative RPM ratio between a gearbox input shaft RPM and a steering shaft RPM in accordance with a steering shaft rotational angle for one complete revolution.

Analyzing graphs of speeds of the steering shaft assembly for phasing compliance may further entail visually inspecting graphs of: an intermediate shaft RPM versus a steering shaft rotational angle for one complete revolution; and a gearbox input shaft RPM versus a steering shaft rotational angle for one complete revolution, to verify the RPM phase relationship of the graphs relative to each other, relative to a steering shaft angle.

Analyzing graphs of the relative RPM ratios of shafts of the steering shaft assembly for relative speed phase compliance may further entail visually inspecting the graphs to verify that relative RPM plots of the gearbox input shaft 18 and the intermediate shaft 16 are directly out of phase with the relative RPM plot of the intermediate shaft 16 and the steering shaft 14.

Analyzing graphs of the relative RPM ratios of shafts 14, 16, 18 of the steering shaft assembly 12 for relative speed phase compliance may further entail visually inspecting the relative RPM plot of the gearbox input shaft RPM and the steering shaft RPM to verify that a RPM speed mismatch is less than 5%.

Still yet another method of phasing u-joints of a steering shaft assembly may entail: generating a computer-aided image of the steering shaft assembly based on steering shaft assembly coordinates; performing kinematics calculations of the steering shaft assembly using the computer-aided design image and arriving at kinematics calculation results; exporting the kinematics calculation results to a spreadsheet; graphing relative steering shaft assembly speeds relative to a rotational position of the steering shaft assembly in accordance with the kinematics data; and comparing graphs of the steering shaft assembly speeds. The steering shaft assembly speeds are the individual speeds of each of the shafts of the steering shaft assembly, such as the steering shaft 14, intermediate shaft 16, and gearbox input shaft 18. For instance, FIG. 11 depicts the speed plot 122 of the steering shaft 14, the speed plot 124 of the intermediate shaft 16, and the speed plot 126 of the gearbox input shaft 18 through one complete rotation of the steering shaft 14. One desire of phasing of the yokes 30, 42, in accordance with the teachings of the present invention, is to ensure that the plots of the speeds of the steering shaft 14 and gearbox input shaft 18 coincide, or are as close to being equal, as possible.

Additionally, the method may entail comparing graphs of the shafts 14, 16, 18 of the steering shaft assembly to ensure that relative shaft speeds are speed compliance. For instance, FIG. 12 depicts relative speed plots 128, 130, 132 for all shaft 14, 16, 18 combinations. Of particular interest is the plot 132 of the relative speed difference between the steering shaft 14 and the gearbox input shaft 18. Maintaining the relative speed difference of these two shafts to within 5% is desired to prevent any knuckling feeling from transmitting through the steering wheel to the hands of a vehicle driver. By comparing the plot to a scale of Relative RPM ratio and inspecting such plot 132, compliance with such a requirement may be made. Relative speed differences of plots 128 and 130 may also be made. When the maximum relative speed ratio of plot 128 and plot 130 are equal, then the relative RPM speed ratio of plot 132 will be most nearly zero. Comparing and inspecting plots 128 and 130 for compliance of the equal maximum relative speed ratio is thus advantageous, as is comparing and inspecting plot 132 for compliance relative to the 5% guideline previously discussed. Speeds may be expressed as an angular velocity or an RPM.

Continuing, generating a computer-aided image of the steering shaft assembly 12 based on steering shaft assembly coordinates may further entail inputting coordinates for a steering shaft 14, an intermediate shaft 16, and a gearbox input shaft 18. Inputting coordinates may entail inputting directly into a CAD program such as CATIA V5 or from a spreadsheet application such that the CAD program imports the coordinates from the spreadsheet. Upon CAD modeling of the assembly 12, calculating relative RPM ratios, for one revolution of the steering shaft 14, between the gearbox input shaft 18 and the intermediate shaft 16, between the intermediate shaft 16 and the steering shaft 14, between the gearbox input shaft 18 and the steering shaft 14 may be performed.

Performing kinematics calculations of the steering shaft assembly may further entail: calculating a revolution time interval for the steering shaft 14; calculating a gearbox input shaft angle at the revolution time interval; calculating a steering shaft angle at the revolution time interval; calculating a gearbox input shaft angular speed at the revolution time interval; calculating an intermediate shaft angular speed at the revolution time interval; and calculating a steering shaft angular speed at the revolution time interval.

Graphing steering shaft assembly speeds relative to a rotational position of the steering shaft assembly may further entail: graphing a steering shaft RPM versus a steering shaft rotational angle for one complete revolution; graphing an intermediate shaft RPM versus a steering shaft rotational angle for one complete revolution; and graphing a gearbox input shaft RPM versus a steering shaft rotational angle for one complete revolution.

Graphing steering shaft assembly speeds relative to a rotational position of the steering shaft assembly may further entail: graphing a relative RPM ratio between a gearbox input shaft RPM and an intermediate shaft RPM in accordance with a steering shaft rotational angle for one complete revolution; graphing a relative RPM ratio between an intermediate shaft RPM and a steering shaft RPM in accordance with a steering shaft rotational angle for one complete revolution; and graphing a relative RPM ratio between a gearbox input shaft RPM and a steering shaft RPM in accordance with a steering shaft rotational angle for one complete revolution. Upon computer graphing, visually inspecting the graphs of FIGS. 11 and 12 to verify that relative RPM plots of the gearbox input shaft and the intermediate shaft are directly out of phase with the relative RPM plot of the intermediate shaft and the steering shaft is performed.

Phasing of the yokes 30, 42 on either end of the intermediate shaft 16 is then calculated by the kinematics module of the CATIA V5 software package. Such kinematics module is capable of performing calculations pertaining to Cardan joints 20, 22 that join shafts on either side of such joint.

Finally, upon completion of a successful phasing calculation, that is, one that meets the velocity matching (within 5%) of the steering shaft 14 and the gearbox input shaft 18, that meets the coupling angle PtB, PtC limit requirements, and that meets the coupling angle difference requirements, the input coordinates of the points A-D may be stored in a spreadsheet for future reference as successful assemblies from which to design.

The description of the invention is merely exemplary in nature and, thus, variations that do not depart from the gist of the invention are intended to be within the scope of the invention. Such variations are not to be regarded as a departure from the spirit and scope of the invention.

What is claimed is.

1. A method of phasing ujoints of a steering shaft assembly comprising:
inputting steering shaft assembly coordinates to a first spreadsheet;
generating a computer-aided design image of the steering shaft assembly based on the steering shaft assembly coordinates;
performing kinematics calculations of the steering shaft assembly using the computer-aided design image;
exporting kinematics calculations results to a second spreadsheet;
graphing relative steering shaft assembly speeds relative to a rotational position of the steering shaft assembly in accordance with the kinematics data;
analyzing graphs of the steering shaft assembly speeds for phasing compliance; and
analyzing graphs of the steering shaft assembly speeds for relative speed compliance.

2. The method of claim 1, wherein inputting the steering shaft assembly coordinates further comprises inputting coordinates for a steering shaft, an intermediate shaft, and a gearbox input shaft.

3. The method of claim 1, wherein generating a computer-aided design image of the steering shaft assembly further comprises generating a three-dimensional image.

4. The method of claim 1, further comprising:
calculating relative RPM ratios, for one revolution of the steering shaft, between the input gearbox shaft and the intermediate shaft, between intermediate shaft and the steering shaft, between the gearbox input shaft and the steering shaft.

5. The method of claim 1, wherein performing kinematics calculations of the steering shaft assembly further comprises:
calculating a revolution time interval for the steering shaft;
calculating a gearbox input shaft angle at the revolution time interval;
calculating a steering shaft angle at the revolution time interval;
calculating a gearbox input shaft angular speed at the revolution time interval;
calculating an intermediate shaft angular speed at the revolution time interval; and
calculating a steering shaft angular speed at the revolution time interval.

6. The method of claim 1, wherein exporting kinematics calculations results to a second spreadsheet further comprises arranging the calculations in order according to a rotational position of the steering shaft assembly;

7. The method of claim 1, wherein graphing steering shaft assembly speeds relative to a rotational position of the steering shaft assembly further comprises:
graphing a steering shaft RPM versus a steering shaft rotational angle for one complete revolution;
graphing an intermediate shaft RPM versus a steering shaft rotational angle for one complete revolution; and
graphing a gearbox input shaft RPM versus a steering shaft rotational angle for one complete revolution.

8. The method of claim 1, wherein graphing steering shaft assembly speeds relative to a rotational position of the steering shaft assembly further comprises:
graphing a relative RPM ratio between a gearbox input shaft RPM and an intermediate shaft RPM in accordance with a steering shaft rotational angle for one complete revolution;
graphing a relative RPM ratio between an intermediate shaft RPM and a steering shaft RPM in accordance with a steering shaft rotational angle for one complete revolution; and
graphing a relative RPM ratio between a gearbox input shaft RPM and a steering shaft RPM in accordance with a steering shaft rotational angle for one complete revolution.

9. The method of claim 1, wherein analyzing graphs of speeds of the steering shaft assembly for phasing compliance further comprises:
visually inspecting the graphs of:
an intermediate shaft RPM versus a steering shaft rotational angle for one complete revolution; and
a gearbox input shaft RPM versus a steering shaft rotational angle for one complete revolution, to verify the RPM phase relationship of the graphs relative to each other, relative to a steering shaft angle.

10. The method of claim 1, wherein analyzing graphs of the relative RPM ratios of shafts of the steering shaft assembly for relative speed phase compliance further comprises:
visually inspecting the graphs to verify that relative RPM plots of the gearbox input shaft and the intermediate shaft are directly out of phase with the relative RPM plot of the intermediate shaft and the steering shaft.

11. The method of claim 1, wherein analyzing graphs of the relative RPM ratios of shafts of the steering shaft assembly for relative speed phase compliance further comprises:
visually inspecting the relative RPM plot of the gearbox input shaft RPM and the steering shaft RPM to verify that a RPM speed mismatch is less than 5%.

12. A method of phasing u-joints of a steering shaft assembly comprising:
generating a computer-aided image of the steering shaft assembly based on steering shaft assembly coordinates;
performing kinematics calculations of the steering shaft assembly using the computer-aided design image and arriving at kinematics calculation results;
exporting the kinematics calculation results to a spreadsheet;
graphing relative steering shaft assembly speeds relative to a rotational position of the steering shaft assembly in accordance with the kinematics data; and
comparing graphs of the steering shaft assembly speeds to compliant shaft speeds.

13. The method of claim 12 further comprising:
comparing graphs of the steering shaft assembly speeds for relative speed compliance.

14. The method of claim 12, wherein generating a computer-aided image of the steering shaft assembly based on steering shaft assembly coordinates further comprises:
inputting coordinates for a steering shaft, an intermediate shaft, and a gearbox shaft.

15. The method of claim 14, wherein inputting coordinates for a steering shaft, an intermediate shaft, and a gearbox shaft further comprises inputting coordinates from a CAD system to a spreadsheet.

16. The method of claim 15 further comprising:
calculating relative RPM ratios, for one revolution of the steering shaft, between the input gearbox shaft and the intermediate shaft, between intermediate shaft and the steering shaft, and between the gearbox input shaft and the steering shaft.

17. The method of claim 16, wherein performing kinematics calculations of the steering shaft assembly further comprises:
calculating a revolution time interval for the steering shaft;
calculating a gearbox input shaft rotational angle at the revolution time interval;
calculating a steering shaft rotational angle at the revolution time interval;
calculating a gearbox input shaft speed at the revolution time interval;
calculating an intermediate shaft speed at the revolution time interval; and
calculating a steering shaft speed at the revolution time interval.

18. The method of claim 12, wherein graphing steering shaft assembly speeds relative to a rotational position of the steering shaft assembly further comprises:
graphing a steering shaft RPM versus a steering shaft rotational angle for one complete revolution;
graphing an intermediate shaft RPM versus a steering shaft rotational angle for one complete revolution; and
graphing a gearbox input shaft RPM versus a steering shaft rotational angle for one complete revolution.

19. The method of claim 12, wherein graphing steering shaft assembly speeds relative to a rotational position of the steering shaft assembly further comprises:
graphing a relative RPM ratio between a gearbox input shaft RPM and an intermediate shaft RPM in accordance with a steering shaft rotational angle for one complete revolution;
graphing a relative RPM ratio between an intermediate shaft RPM and a steering shaft RPM in accordance with a steering shaft rotational angle for one complete revolution; and
graphing a relative RPM ratio between a gearbox input shaft RPM and a steering shaft RPM in accordance with a steering shaft rotational angle for one complete revolution.

20. The method of claim 19 further comprising:
visually inspecting the graphs to verify that relative RPM plots of the gearbox input shaft and the intermediate shaft are oppositely out of phase with the relative RPM plot of the intermediate shaft and the steering shaft.
